(19) United States
(12) Patent Application Publication
(10) Pub. No.: US 2026/0254659 A1
(43) Pub. Date: Aug. 27, 2026

(54) METHOD AND SYSTEM FOR SECURE DATA TRANSMISSION

(71) Applicant: XPERIX INC., Seongnam-si (KR)

(72) Inventors: Wonseok AHN, Seongnam-si (KR); Hunmin KA, Seongnam-si (KR)

(21) Appl. No.: 19/649,932

(22) Filed: Apr. 16, 2026

Related U.S. Application Data
(63) Continuation of application No. PCT/KR2024/015412, filed on Oct. 11, 2024.

(30) Foreign Application Priority Data
Oct. 16, 2023 (KR) 10-2023-0137773

(51) Int. Cl. H04L 9/32; H04L 9/08

(52) U.S. Cl. CPC H04L 9/3247; H04L 9/0822; H04L 9/0825

(57) ABSTRACT

A secure data transmission method executed by at least one processor, includes receiving encrypted data from a sender, receiving an encrypted encryption key from the sender, checking whether a receiver possesses a receiver private key, and if the receiver possesses the receiver private key, transmitting the encrypted data and the encrypted encryption key to the receiver.

### CROSS-REFERENCE TO RELATED APPLICATION

This application is a continuation of International Application No. PCT/KR2024/015412 filed on October 11, 2024, which claims the benefit of priority to Korean Patent Application No. 10-2023-0137773 filed on October 16, 2023, the entire contents of which are hereby incorporated by reference.

### TECHNICAL FIELD

The present disclosure relates to method and system for secure data transmission.

### BACKGROUND

As data exchange becomes more active in modern society, the importance of data transmission technology is further increasing, and technology for efficiently and safely transmitting data is emerging as an important task for companies, institutions, and individuals alike. Data transmission technology refers to technology used to move data to another place or system, and the core goal is to maintain the integrity and security of data during the transmission process.

As conventional techniques for transmitting data, a method of transmitting data in real-time through a network between a sender and a receiver or a method of transmitting data in non-real-time using a relay server are utilized. However, in the case of the real-time data transmission method, there is a problem in that excessive time is required because the terminals of both the sending and receiving sides must participate in the data transmission process, and in the case of the non-real-time data transmission method using a relay server, there is a problem in that a risk of data leakage exists due to the intervention of an untrusted intermediary. Accordingly, improvements are required to achieve both convenience and security of data transmission simultaneously.

### SUMMARY

The present disclosure provides a secure data transmission method, a computer program stored in a recording medium, and a system (apparatus) to solve the problems described above.

The present disclosure may be implemented in various ways including a method, a system (apparatus), or a computer program stored in a readable storage medium.

According to an aspect of the present disclosure, a secure data transmission method executed by at least one processor includes receiving encrypted data from a sender, receiving an encrypted encryption key from the sender, checking whether a receiver possesses a private key, and, if the receiver possesses the private key, transmitting the encrypted data and the encrypted encryption key to the receiver.

According to an aspect of the present disclosure, the encryption key may be encrypted based on a sender private key and a receiver public key, and the encrypted encryption key is decrypted based on a receiver private key and a sender public key.

According to an aspect of the present disclosure, a secure data transmission method executed by at least one processor includes receiving encrypted data from a sender, receiving receiver identification information from the sender, receiving a receiver public key from a receiver, checking for receiver identification information and whether the receiver possesses a receiver private key from the receiver, if the receiver possesses the receiver identification information and the receiver private key, transmitting the receiver public key to the sender, receiving an encrypted encryption key from the sender, and transmitting the encrypted data and the encrypted encryption key to the receiver.

According to an aspect of the present disclosure, checking for the receiver identification information and whether the receiver possesses the receiver private key from the receiver may include receiving receiver identification information possessed by the receiver from the receiver, and comparing the receiver identification information received from the sender with the receiver identification information possessed by the receiver, wherein the identification information received from the sender and the identification information possessed by the receiver are one-way encrypted.

According to an aspect of the present disclosure, the method may further include verifying the receiver identification information possessed by the receiver.

According to an aspect of the present disclosure, verifying the receiver identification information possessed by the receiver may include receiving verification information from a database of a verification authority, checking validity of a signature included in the verification information using a verification authority public key, and comparing the verification information with the receiver identification information possessed by the receiver.

According to an aspect of the present disclosure, the encrypted encryption key may be encrypted based on a sender private key and a receiver public key, and decrypted based on a receiver private key and a sender public key.

A computer program stored in a computer-readable recording medium for executing the above-described method on a computer is provided.

An information processing system may include a communication module, a memory, and at least one processor connected to the memory and configured to execute at least one computer-readable program included in the memory, wherein the at least one program includes instructions for receiving encrypted data from a sender, receiving an encrypted encryption key from the sender, checking whether a receiver possesses a receiver private key, and, if the receiver possesses the receiver private key, transmitting the encrypted data and the encrypted encryption key to the receiver.

An information processing system may include a communication module, a memory, and at least one processor connected to the memory and configured to execute at least one computer-readable program included in the memory, wherein the at least one program includes instructions for receiving encrypted data from a sender, receiving receiver identification information from the sender, receiving a receiver public key from a receiver, checking for receiver identification information and whether the receiver possesses a receiver private key from the receiver, if the receiver possesses the receiver identification information and the receiver private key, transmitting the receiver public key to the sender, receiving an encrypted encryption key from the sender, and transmitting the encrypted data and the encrypted encryption key to the receiver.

An apparatus may include a communication interface, at least one processor, and a memory storing instructions configured to be executed by the at least one processor to cause the apparatus to: receive, via the communication interface, encrypted data from a sender, receive, via the communication interface, an encrypted encryption key from the sender, perform a cryptographic verification, using digital signature technology, on information generated with a receiver private key, determine, based on the cryptographic verification, that a receiver possesses the receiver private key, and transmit, via the communication interface and based on determining that the receiver possesses the receiver private key, the encrypted data and the encrypted encryption key to the receiver.

According to various aspects of the present disclosure, encrypted data and an encrypted encryption key may be transmitted to a receiver through a secure data transmission system that is an intermediary. Accordingly, the security of synchronized communication and the convenience of asynchronized communication may be secured simultaneously.

According to various aspects of the present disclosure, an encryption key may be encrypted based on a private key of a sender and a public key of a receiver. Accordingly, data cannot be arbitrarily viewed by an intermediary, and the data to be transmitted can be safely protected even against data leakage due to accidents such as hacking.

According to various aspects of the present disclosure, data encryption and encryption key encryption may be performed with a time difference, and data encryption and an encrypted data transmission procedure may be performed even if a receiver is not determined. Accordingly, efficiency of data transmission between the sender and the receiver can be improved.

According to various aspects of the present disclosure, a procedure for verifying receiver identification information possessed by a receiver through a verification authority may be performed. Accordingly, the reliability of the receiver can be secured, and data leakage that may occur as data is transmitted to an unidentified receiver can be prevented.

The effects of the present disclosure are not limited to the effects mentioned above, and other effects not mentioned will be clearly understood by those of ordinary skill in the art to which the present disclosure pertains (hereinafter referred to as a "person skilled in the art") from the description of the claims.

### BRIEF DESCRIPTION OF THE DRAWINGS

Various features of the present disclosure will be described with reference to the accompanying drawings described below, wherein like reference numerals represent like elements, but are not limited thereto.

FIG. 1 is a view of an example in which a sender transmits data to a receiver according to an example of the present disclosure.

FIG. 2 is a schematic diagram illustrating a configuration in which an information processing system is communicatively connected to a plurality of user terminals to transmit data according to an example of the present disclosure.

FIG. 3 is a block diagram illustrating internal configurations of a user terminal and an information processing system according to an example of the present disclosure.

FIG. 4 is a view of an example of a secure data transmission procedure performed among a sender, a secure data transmission system, and a receiver according to an example of the present disclosure.

FIG. 5 is a view of an example of a secure data transmission procedure performed among a sender, a secure data transmission system, a receiver, a verification authority, and a public DB according to an example of the present disclosure.

FIG. 6 is a flowchart illustrating an example of a secure data transmission method according to an example of the present disclosure.

FIG. 7 is a flowchart illustrating another example of a secure data transmission method according to an example of the present disclosure.

### DETAILED DESCRIPTION

Hereinafter, specific details for the practice of the present disclosure will be described in detail with reference to the accompanying drawings. However, in the following description, detailed descriptions of well-known functions or configurations will be omitted if there is a concern that they may unnecessarily obscure the gist of the present disclosure.

In the accompanying drawings, the same or corresponding components are given the same reference numerals. Also, in the description of the following example features, redundant description of the same or corresponding components may be omitted. However, even if the description of a component is omitted, it is not intended that such a component is not included in a certain example.

Advantages and features of the disclosed embodiment(s), and methods of achieving them, will become clear with reference to the example features described below in conjunction with the accompanying drawings. However, the present disclosure is not limited to the example features disclosed below but may be implemented in various different forms, and these example features are merely provided to make the present disclosure complete and to fully inform the scope of the invention to those skilled in the art.

Terms used in this specification will be briefly described, and the disclosed example features will be described in detail. The terms used in this specification have selected general terms that are currently widely used as much as possible while considering functions in the present disclosure, but this may vary depending on the intention of a technician engaged in the related field, precedents, or the emergence of new technologies. Also, in specific cases, there are terms arbitrarily selected by the applicant, and in this case, the meaning will be described in detail in the corresponding description section of the invention. Therefore, the terms used in the present disclosure should be defined based on the meaning of the terms and the content throughout the present disclosure, rather than simple names of the terms.

In this specification, singular expressions include plural expressions unless the context clearly specifies otherwise as singular. Also, plural expressions include singular expressions unless the context clearly specifies otherwise as plural. Throughout the specification, when a part is said to "include" a certain component, it means that it may further include other components rather than excluding other components unless specifically stated otherwise.

Also, the term "module" or "unit" used in the specification means a software or hardware component, and the "module" or "unit" performs certain roles. However, "module" or "unit" is not limited to software or hardware. A "module" or "unit" may be configured to reside in an addressable storage medium or may be configured to reproduce one or more processors. Thus, as an example, a "module" or "unit" may include components such as software components, object-oriented software components, class components, and task components, and at least one of processes, functions, attributes, procedures, subroutines, segments of program code, drivers, firmware, microcode, circuits, data, databases, data structures, tables, arrays, or variables. The functions provided within the components and "modules" or "units" may be combined into a smaller number of components and "modules" or "units" or further separated into additional components and "modules" or "units."

According to an example of the present disclosure, a "module" or "unit" may be implemented with a processor and a memory. A "processor" should be interpreted broadly to include a general-purpose processor, a central processing unit (CPU), a microprocessor, a digital signal processor (DSP), a controller, a microcontroller, a state machine, and the like. In some environments, a "processor" may also refer to an application-specific integrated circuit (ASIC), a programmable logic device (PLD), a field-programmable gate array (FPGA), and the like. A "processor" may also refer to a combination of processing devices, such as, for example, a combination of a DSP and a microprocessor, a combination of a plurality of microprocessors, a combination of one or more microprocessors combined with a DSP core, or any other such combination of configurations. Also, "memory" should be interpreted broadly to include any electronic component capable of storing electronic information. "Memory" may also refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and the like. If a processor can read information from and/or write information to a memory, the memory is said to be in electronic communication with the processor. A memory integrated into a processor is in electronic communication with the processor.

In the present disclosure, a "system" may include at least one device among a server device and a cloud device, but is not limited thereto. For example, a system may be composed of one or more server devices. As another example, a system may be composed of one or more cloud devices. As yet another example, a system may be operated by configuring a server device and a cloud device together.

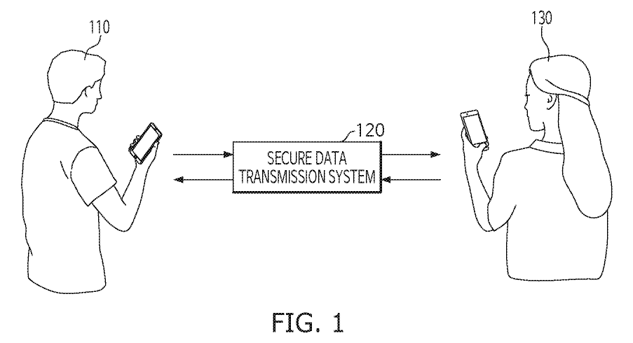

FIG. 1 is a view of an example in which a sender 110 transmits data to a receiver 130 according to an example of the present disclosure. As shown in FIG. 1, in transmitting data from the sender 110 to the receiver 130, a secure data transmission system 120 may perform an intermediary role.

According to an example, the secure data transmission system 120 may receive encrypted data and an encrypted encryption key from the sender 110. In this case, the data to be transmitted may be encrypted by the sender 110. For example, the sender 110 may encrypt data using an encryption key generated as a random number satisfying a predetermined complexity. Similarly, the encryption key used for data encryption may also be encrypted by the sender 110. For example, the sender 110 may encrypt the encryption key based on a sender private key and a receiver public key.

According to an example, the secure data transmission system 120 may check whether the receiver 130 possesses a receiver private key. For example, the secure data transmission system 120 may check whether the receiver 130 possesses the receiver private key without receiving the key directly from the receiver 130 by utilizing digital signature technology (e.g., ECDSA, RSA, etc.).

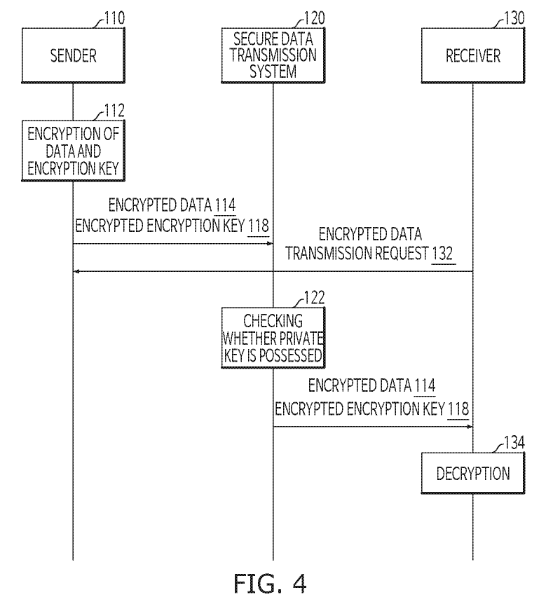

According to an example, if the receiver 130 possesses the receiver private key, the secure data transmission system 120 may transmit the encrypted data and the encrypted encryption key to the receiver 130. The receiver 130 may decrypt the encrypted encryption key based on the receiver private key and a sender public key. Thereafter, the receiver 130 may receive the data to be transmitted by decrypting the encrypted data using the decrypted encryption key. Details of the above-described data transmission procedure will be described in detail later with reference to FIG. 4.

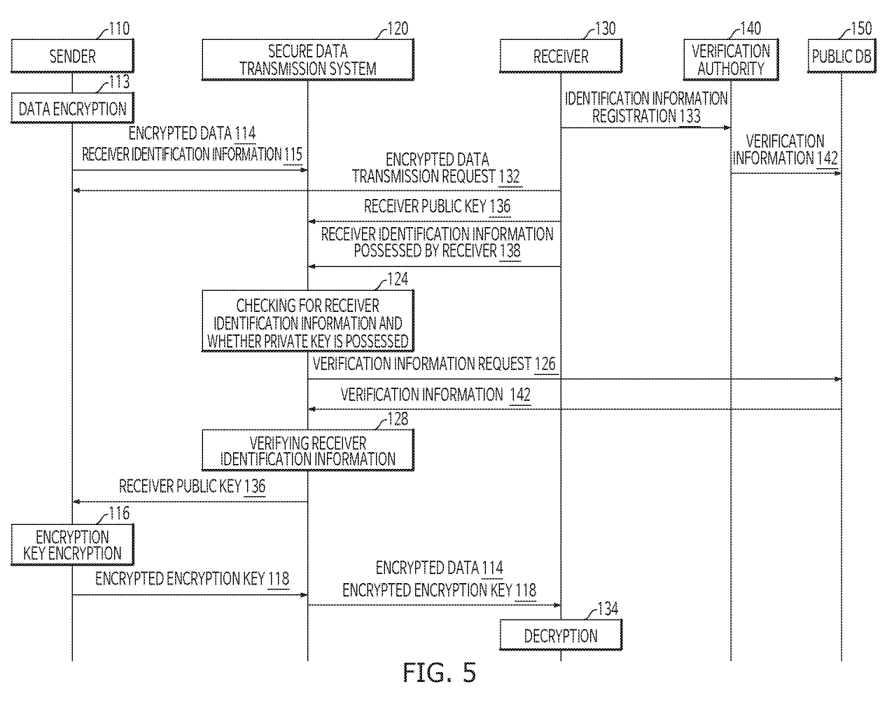

Additionally, the secure data transmission system 120 may receive receiver identification information from the sender 110 and check whether the receiver 130 possesses the corresponding receiver identification information. Then, if it is confirmed that the receiver 130 possesses the receiver identification information, the secure data transmission system 120 may transmit a receiver public key received from the receiver 130 to the sender 110. The sender 110 may encrypt an encryption key based on the receiver public key received from the secure data transmission system 120 and the sender private key, and may transmit the encrypted encryption key to the secure data transmission system 120 with a time difference from the encrypted data. Details of this will be described in detail later with reference to FIG. 5.

Additionally, the secure data transmission system 120 may verify the receiver identification information possessed by the receiver 130 through a verification authority. For example, if the receiver identification information possessed by the receiver is an e-mail address, the e-mail address and the ownership of this address may be verified through a verification authority (e.g., an e-mail service provider, etc.). Details of this will be described in detail later with reference to FIG. 5.

According to conventional technology for transmitting data, data transmission is performed in a manner in which a sender and a receiver are directly connected through a network to transmit data. However, such a method required both the sender and the receiver to participate in real-time communication, and if the receiver's standby for reception is not performed immediately or if a performance difference of terminals exists, there is a problem in that excessive time is required, such as the sender having to wait for a long time until the receiver becomes a receivable state.

As another method, data transmission is performed in a manner in which a sender stores data in a relay server, and the relay server transmits the file to an authenticated receiver. However, such a method has a problem in that a complicated authentication process is required to secure the reliability of the relay server as the data transmitted to the relay server is temporarily stored, and there is a problem in that there is a risk of leakage of data content during the relay process.

The secure data transmission method according to the present disclosure described above can enable data transmission between a sender and a receiver in non-real-time by transmitting data through a secure data transmission system that is an intermediary. In addition, as the encryption key is encrypted through secret information shared only by the sender and the receiver, the risk of data leakage due to the intervention of an intermediary in the data transmission process can be prevented. Accordingly, the security of synchronized end-to-end communication and the convenience of asynchronized communication can be secured simultaneously.

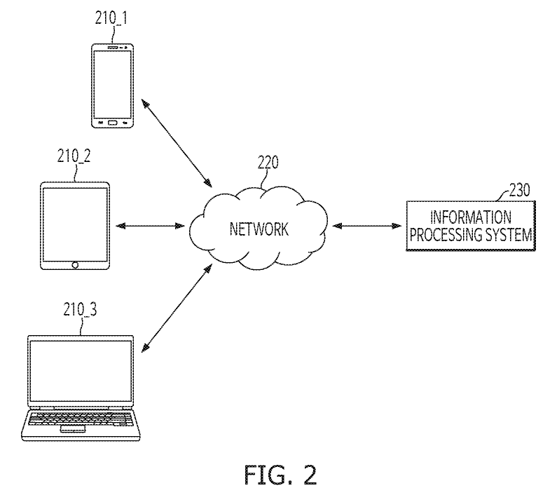

FIG. 2 is a schematic diagram illustrating a configuration in which an information processing system 230 is communicatively connected to a plurality of user terminals 210_1, 210_2, and 210_3 to transmit data according to an example of the present disclosure. As shown, the plurality of user terminals 210_1, 210_2, and 210_3 may be connected to the information processing system 230 capable of transmitting data through a network 220. Here, the plurality of user terminals 210_1, 210_2, and 210_3 may correspond to the terminals of the sender 110 and/or the receiver 130 of FIG. 1. Also, the information processing system 230 may correspond to the secure data transmission system 120 of FIG. 1.

In an example, the information processing system 230 may include one or more server devices and/or databases capable of storing, providing, and executing computer-executable programs associated with data transmission (for example, downloadable applications) and data, or one or more distributed computing devices and/or distributed databases based on cloud computing services.

Data transmitted by the information processing system 230 may be transmitted to a user through a data transmission application, a web browser, or a web browser extension installed in each of the plurality of user terminals 210_1, 210_2, and 210_3. For example, the information processing system 230 may provide data corresponding to a data transmission request received from the user terminals 210_1, 210_2, and 210_3 through a data transmission application or the like or perform corresponding processing.

The plurality of user terminals 210_1, 210_2, and 210_3 may communicate with the information processing system 230 through the network 220. The network 220 may be configured to enable communication between the plurality of user terminals 210_1, 210_2, and 210_3 and the information processing system 230. Depending on the installation environment, the network 220 may be composed of, for example, a wired network such as Ethernet, a wired home network (Power Line Communication), a telephone line communication device, and RS-serial communication, a wireless network such as a mobile communication network, WLAN (Wireless LAN), Wi-Fi, Bluetooth, and ZigBee, or a combination thereof. The communication method is not limited, and may include not only communication methods utilizing communication networks that the network 220 may include (for example, mobile communication networks, wired Internet, wireless Internet, broadcasting networks, satellite networks, etc.) but also short-range wireless communication between user terminals 210_1, 210_2, and 210_3.

In FIG. 2, a mobile phone terminal 210_1, a tablet terminal 210_2, and a PC terminal 210_3 are shown as examples of user terminals, but are not limited thereto, and the user terminals 210_1, 210_2, and 210_3 may be any computing devices in which wired and/or wireless communication is possible and a data transmission service application or a web browser can be installed and executed. For example, a user terminal may include an AI speaker, a smartphone, a mobile phone, a navigation system, a computer, a notebook, a terminal for digital broadcasting, PDA (Personal Digital Assistants), PMP (Portable Multimedia Player), a tablet PC, a game console, a wearable device, an IoT (internet of things) device, a VR (virtual reality) device, an AR (augmented reality) device, a set-top box, and the like. Also, although FIG. 2 is a view of three user terminals 210_1, 210_2, and 210_3 communicating with the information processing system 230 through the network 220, it is not limited thereto, and a different number of user terminals may be configured to communicate with the information processing system 230 through the network 220.

In FIG. 2, a configuration in which the user terminals 210_1, 210_2, and 210_3 transmit or receive data by communicating with the information processing system 230 is illustratively shown, but is not limited thereto, and a user's request or input may be provided to the information processing system 230 through an input device associated with the information processing system 230 without going through the user terminals 210_1, 210_2, and 210_3, and a result of processing the user's request or input may be provided to the user through an output device (e.g., a display, etc.) associated with the information processing system 230.

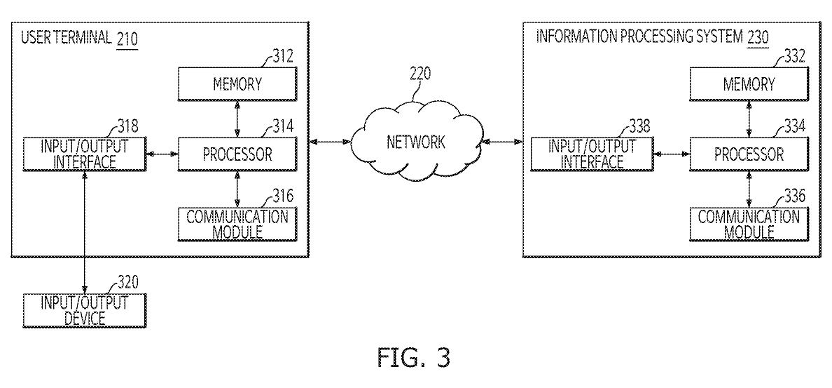

FIG. 3 is a block diagram illustrating internal configurations of a user terminal 210 and an information processing system 230 according to an example of the present disclosure. The user terminal 210 may refer to any computing device capable of executing applications, web browsers, etc., and capable of wired/wireless communication, and may include, for example, the mobile phone terminal 210_1, the tablet terminal 210_2, the PC terminal 210_3 of FIG. 2, and the like. As shown, the user terminal 210 may include a memory 312, a processor 314, a communication module 316, and an input/output interface 318. Similarly, the information processing system 230 may include a memory 332, a processor 334, a communication module 336, and an input/output interface 338. As shown in FIG. 3, the user terminal 210 and the information processing system 230 may be configured to communicate information and/or data through the network 220 using respective communication modules 316 and 336. Also, an input/output device 320 may be configured to input information and/or data to the user terminal 210 through the input/output interface 318 or output information and/or data generated from the user terminal 210.

The memories 312 and 332 may include any non-transitory computer-readable recording media. According to an example, the memories 312 and 332 may include permanent mass storage devices such as ROM (read only memory), disk drives, SSD (solid state drive), flash memory, and the like. As another example, permanent mass storage devices such as ROM, SSD, flash memory, disk drives, etc. may be included in the user terminal 210 or the information processing system 230 as separate permanent storage devices distinguished from the memory. Also, an operating system and at least one program code may be stored in the memories 312 and 332.

These software components may be loaded from computer-readable recording media separate from the memories 312 and 332. Such separate computer-readable recording media may include recording media directly connectable to the user terminal 210 and the information processing system 230, and may include computer-readable recording media such as, for example, floppy drives, disks, tapes, DVD/CD-ROM drives, memory cards, and the like. As another example, software components may be loaded into the memories 312 and 332 through the communication modules 316 and 336 rather than computer-readable recording media. For example, at least one program may be loaded into the memories 312 and 332 based on computer programs installed by files provided through the network 220 by developers or file distribution systems that distribute installation files of applications.

The processors 314 and 334 may be configured to process instructions of computer programs by performing basic arithmetic, logic, and input/output operations. Instructions may be provided to the processors 314 and 334 by the memories 312 and 332 or the communication modules 316 and 336. For example, the processors 314 and 334 may be configured to execute received instructions according to program code stored in recording devices such as the memories 312 and 332.

The communication modules 316 and 336 may provide configurations or functions for the user terminal 210 and the information processing system 230 to communicate with each other through the network 220, and may provide configurations or functions for the user terminal 210 and/or the information processing system 230 to communicate with other user terminals or other systems (for example, separate cloud systems, etc.). For example, a request or data (for example, a data transmission request, etc.) generated by the processor 314 of the user terminal 210 according to program code stored in a recording device such as the memory 312 may be delivered to the information processing system 230 through the network 220 under the control of the communication module 316. Conversely, control signals or instructions provided under the control of the processor 334 of the information processing system 230 may be received by the user terminal 210 through the communication module 316 of the user terminal 210 via the communication module 336 and the network 220.

The input/output interface 318 may be a means for interface with the input/output device 320. As an example, the input device may include devices such as a camera including an audio sensor and/or an image sensor, a keyboard, a microphone, a mouse, and the like, and the output device may include devices such as a display, a speaker, a haptic feedback device, and the like. As another example, the input/output interface 318 may be a means for interface with a device in which configurations or functions for performing input and output are integrated into one, such as a touch screen. For example, in processing instructions of a computer program loaded in the memory 312, the processor 314 of the user terminal 210 may display a service screen or the like configured using information and/or data provided by the information processing system 230 or another user terminal on a display through the input/output interface 318. In FIG. 3, the input/output device 320 is shown not to be included in the user terminal 210, but is not limited thereto, and may be configured as one device with the user terminal 210. Also, the input/output interface 338 of the information processing system 230 may be a means for interface with a device (not shown) for input or output that is connected to the information processing system 230 or that the information processing system 230 may include. In FIG. 3, the input/output interfaces 318 and 338 are shown as elements configured separately from the processors 314 and 334, but are not limited thereto, and the input/output interfaces 318 and 338 may be configured to be included in the processors 314 and 334.

The user terminal 210 and the information processing system 230 may include more components than the components of FIG. 3. However, there is no need to clearly show most conventional components. In an example, the user terminal 210 may be implemented to include at least a part of the input/output devices 320 described above. Also, the user terminal 210 may further include other components such as a transceiver, a GPS (Global Positioning System) module, a camera, various sensors, a database, and the like.

While a program for a data transmission application or the like is operating, the processor 314 may receive text, images, videos, voices, and/or motions, etc. input or selected through input devices such as a touch screen, a keyboard, a camera including an audio sensor and/or an image sensor, a microphone, etc. connected to the input/output interface 318, and may store the received text, images, videos, voices, and/or motions, etc. in the memory 312 or provide them to the information processing system 230 through the communication module 316 and the network 220.

The processor 314 of the user terminal 210 may be configured to manage, process, and/or store information and/or data received from the input/output device 320, other user terminals, the information processing system 230, and/or a plurality of external systems. Information and/or data processed by the processor 314 may be provided to the information processing system 230 through the communication module 316 and the network 220. The processor 314 of the user terminal 210 may transmit information and/or data to the input/output device 320 through the input/output interface 318 to output it. For example, the processor 314 may output or display received information and/or data on a screen of the user terminal 210.

The processor 334 of the information processing system 230 may be configured to manage, process, and/or store information and/or data received from the plurality of user terminals 210 and/or a plurality of external systems. Information and/or data processed by the processor 334 may be provided to the user terminal 210 through the communication module 336 and the network 220.

FIG. 4 is a view of an example of a secure data transmission procedure performed among a sender 110, a secure data transmission system 120, and a receiver 130 according to an example of the present disclosure. The secure data transmission procedure may be initiated by the sender 110 encrypting data and an encryption key that are transmission targets (112). The sender 110 may encrypt data that is a transmission target based on an encryption key. In this case, the encryption key may be generated as a random number satisfying a predetermined complexity. Also, the sender 110 may encrypt the encryption key used for data encryption. In this case, the encryption key may be encrypted based on a sender private key of the sender 110 and a receiver public key of the receiver 130, and the sender 110 may receive information about the receiver public key from a predetermined receiver 130.

According to an example, the sender 110 may transmit encrypted data 114 and an encrypted encryption key 118 to the secure data transmission system 120. The sender 110 may transmit the encrypted data 114 and the encrypted encryption key 118 to the secure data transmission system 120 before receiving a data transmission request of the receiver 130. As described above, as the data transmission between the sender 110 and the secure data transmission system 120 is performed in advance, the time required for data transmission can be shortened.

According to an example, the receiver 130 may transmit a transmission request 132 for encrypted data to the sender 110. In FIG. 4, the transmission request 132 for encrypted data is shown to be transmitted to the sender 110 after the encrypted data 114 and the encrypted encryption key 118 are transmitted, but is not limited thereto, and the data transmission request 132 may be transmitted to the sender 110 before encryption of data and the encryption key. Also, although FIG. 4 is a view of the receiver 130 transmitting the data transmission request 132 to the sender 110, it is not limited thereto. The receiver 130 may transmit the data transmission request 132 to the secure data transmission system 120, and the secure data transmission system 120 may deliver the corresponding request to the sender 110.

According to an example, the secure data transmission system 120 may check whether the receiver 130 possesses a receiver private key from the receiver 130 (122). For example, the secure data transmission system 120 may check whether the receiver 130 possesses the receiver private key without receiving the key directly from the receiver 130 by using digital signature technology (e.g., ECDSA, RSA, etc.). Alternatively, the receiver private key may be stored in advance in the secure data transmission system 120. The secure data transmission system 120 may proceed with checking whether the receiver 130 possesses the receiver private key or verifying the receiver private key through comparison with the pre-stored receiver private key.

According to an example, if the receiver 130 possesses the receiver private key, the secure data transmission system 120 may transmit the encrypted data 114 and the encrypted encryption key 118 to the receiver 130. The receiver 130 may decrypt the encrypted data 114 and the encrypted encryption key 118 (134). Specifically, the receiver 130 may decrypt the encrypted encryption key 118 based on the receiver private key and the sender public key, and may receive the data to be transmitted fully by decrypting the encrypted data 114 based on the decrypted encryption key.

Like the configuration described above, the sender 110 transmits data to the receiver 130 through the secure data transmission system 120, whereby data can be transmitted without both the sender 110 and the receiver 130 participating in communication in real-time. In addition, the risk of data leakage can be prevented by encrypting the encryption key through secret information shared only by the sender and the receiver (e.g., the sender private key and the receiver public key, etc.). Accordingly, the sender 110 can transmit data to the receiver 130 through a data transmission technology that simultaneously secures the security of synchronized end-to-end communication and the convenience of asynchronized communication.

FIG. 5 is a view of an example of a secure data transmission procedure performed among a sender 110, a secure data transmission system 120, a receiver 130, a verification authority 140, and a public DB 150 according to an example of the present disclosure. The secure data transmission procedure may be initiated by the sender 110 encrypting data (113). Similar to FIG. 4, the sender 110 may encrypt data to be transmitted based on an encryption key generated as a random number satisfying a predetermined complexity.

According to an example, the sender 110 may transmit encrypted data 114 and receiver identification information 115 to the secure data transmission system 120. The receiver identification information 115 may refer to a means capable of specifying a receiver and checking whether the receiver possesses identification information. For example, the receiver identification information 115 may include a receiver's e-mail address, a receiver's phone number, and the like. Also, the receiver identification information 115 may be one-way encrypted and transmitted to the secure data transmission system 120, and hash encryption technology (e.g., SHA-256, etc.) may be used in this process.

According to an example, the receiver 130 may transmit an encrypted data transmission request 132 to the sender 110. In FIG. 5, the transmission request 132 for encrypted data is shown to be transmitted to the sender 110 after the encrypted data 114 is transmitted, but is not limited thereto, and the data transmission request 132 may be transmitted to the sender 110 before encryption of data. Also, although FIG. 5 is a view of the receiver 130 transmitting the data transmission request 132 to the sender 110, it is not limited thereto. The receiver 130 may transmit the data transmission request 132 to the secure data transmission system 120, and the secure data transmission system 120 may deliver the corresponding request to the sender 110.

According to an example, the receiver 130 may transmit a receiver public key 136 and receiver identification information 138 possessed by the receiver to the secure data transmission system 120. The receiver public key 136 may be transmitted to the sender 110 to be used for encryption key encryption, and the receiver identification information 138 possessed by the receiver may be used for a procedure for checking whether the receiver 130 possesses receiver identification information. The receiver identification information 138 possessed by the receiver may be one-way encrypted and transmitted similar to the receiver identification information 115, and hash encryption technology (e.g., SHA-256, etc.) may be used. In FIG. 5, the receiver public key 136 is shown to be transmitted to the secure data transmission system 120 before checking whether the receiver identification information and private key are possessed, but this is not limited thereto. For example, the receiver public key 136 may be transmitted after checking whether the receiver identification information and private key are possessed and/or after verifying the receiver identification information.

According to an example, the secure data transmission system 120 may check whether the receiver identification information and private key are possessed (124). For example, the secure data transmission system 120 may check whether the receiver 130 possesses receiver identification information by comparing the receiver identification information 115 received from the sender 110 with the receiver identification information 138 possessed by the receiver. Also, the secure data transmission system 120 may check whether the receiver 130 possesses the receiver private key without receiving the key directly from the receiver 130 by using digital signature technology (e.g., ECDSA, RSA, etc.).

According to an example, if the receiver 130 possesses the receiver identification information and the receiver private key, the secure data transmission system 120 may transmit the receiver public key 136 to the sender 110. The sender 110 may encrypt the encryption key based on the receiver public key 136 and the sender private key (116). The sender 110 may transmit the encrypted encryption key 118 to the secure data transmission system 120, and the secure data transmission system 120 may transmit the encrypted data 114 and the encrypted encryption key 118 to the receiver 130.

According to an example, the receiver 130 may decrypt the encrypted data 114 and the encrypted encryption key 118 (134). Specifically, the receiver 130 may decrypt the encrypted encryption key 118 based on the receiver private key and the sender public key, and may receive the data to be transmitted fully by decrypting the encrypted data 114 based on the decrypted encryption key.

Like the configuration described above, data encryption and encryption key encryption may be performed with a time difference, and data encryption and an encrypted data transmission procedure may be performed even if a receiver is not determined. Accordingly, efficiency of data transmission between the sender and the receiver can be improved.

According to an example, before transmitting the data transmission request 132 to the sender, the receiver 130 may register identification information in the verification authority 140 (133). Then, the verification authority 140 may generate verification information 142 based on the registered identification information and then store it in a public DB (e.g., blockchain, etc.). For example, if the receiver identification information is an e-mail address, the verification authority may be an e-mail service provider. Also, the e-mail service provider may generate verification information guaranteeing that the registered e-mail address is a true e-mail address of the receiver and store it in the public DB.

According to an example, the secure data transmission system 120 may transmit a verification information request 126 to the verification authority 140 and/or the public DB 150 of the verification authority to verify the receiver identification information 138 possessed by the receiver, and may verify the receiver identification information based on the received verification information 142 (128). In more detail, the secure data transmission system 120 may verify the receiver identification information by checking the validity of a signature included in the verification information 142 using a verification authority public key and comparing the verification information with the receiver identification information 138 possessed by the receiver. For example, the secure data transmission system 120 may confirm that the true owner of the e-mail address possessed by the receiver is the receiver 130 by checking the validity included in the verification information stored in the public DB using a public key of an e-mail service provider and comparing the verification information with the e-mail information possessed by the receiver. Through the above-described configuration, the reliability of the receiver can be secured, and data leakage that may occur as data is transmitted to an unidentified receiver can be prevented.

Alternatively, the sender 110 may transmit a digital contract in which specific conditions are set to the secure data transmission system 120 instead of the receiver identification information 115. In this case, the secure data transmission system 120 may check from the receiver 130 whether specific conditions specified in the digital contract are met, and may transmit the encrypted data 114 and the encrypted encryption key 118 to the receiver who has met the specific conditions. Through such a configuration, data can be transmitted to an unspecified receiver who has met specific conditions without pre-determining the receiver, and a data transmission technology with higher versatility can be provided to the sender.

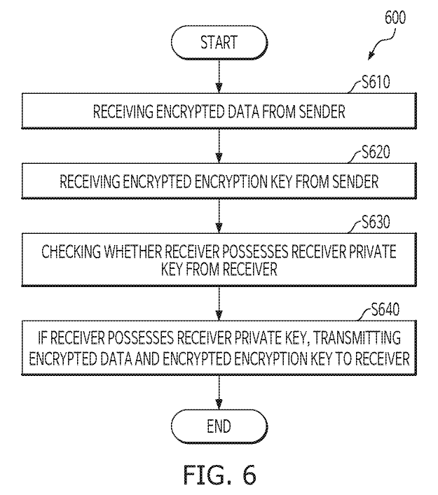

FIG. 6 is a flowchart illustrating an example of a secure data transmission method 600 according to an example of the present disclosure. In an example, the method 600 may be performed by at least one processor (for example, the processor 334 of the information processing system 230, etc.).

The method 600 may be initiated by receiving encrypted data from a sender (S610). Then, the processor may receive an encrypted encryption key from the sender (S620). In an example, the encrypted encryption key may be encrypted based on a sender private key and a receiver public key, and may be decrypted based on a receiver private key and a sender public key.

Then, the processor may check whether the receiver possesses a receiver private key from the receiver (S630). Finally, if the receiver possesses the private key, the processor may transmit the encrypted data and the encrypted encryption key to the receiver (S640).

The flowchart shown in FIG. 6 and the description above are only an example, and may be implemented differently in some examples. For example, in some examples, the order of each step may be changed, some steps may be performed repeatedly, some steps may be omitted, or some steps may be added.

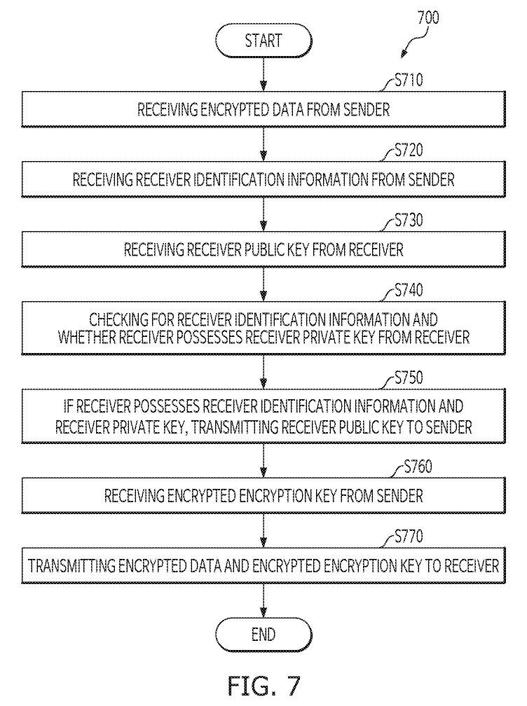

FIG. 7 is a flowchart illustrating another example of a secure data transmission method 700 according to an example of the present disclosure. In an example, the method 700 may be performed by at least one processor (for example, the processor 334 of the information processing system 230, etc.).

The method 700 may be initiated by receiving encrypted data from a sender (S710). Then, the processor may receive receiver identification information from the sender (S720). In an example, an encrypted encryption key may be encrypted based on a sender private key and a receiver public key, and may be decrypted based on a receiver private key and a sender public key. Then, the processor may receive a receiver public key from a receiver (S730).

Then, the processor may check for receiver identification information and whether the receiver possesses a receiver private key from the receiver (S740). In an example, the processor may receive receiver identification information possessed by the receiver from the receiver and compare the receiver identification information received from the sender with the receiver identification information possessed by the receiver. In this case, the receiver identification information received from the sender and the identification information possessed by the receiver may be one-way encrypted.

Then, if the receiver possesses the receiver identification information and the receiver private key, the processor may transmit the receiver public key to the sender (S750). Finally, the processor receives an encrypted encryption key from the sender (S760) and may transmit the encrypted data and the encrypted encryption key to the receiver (S770).

In an example, the processor may verify the receiver identification information possessed by the receiver. The processor may receive verification information from a database of a verification authority, check validity of a signature included in the verification information using a verification authority public key, and compare the verification information with the receiver identification information possessed by the receiver.

The flowchart shown in FIG. 7 and the description above are only an example, and may be implemented differently in some examples. For example, in some examples, the order of each step may be changed, some steps may be performed repeatedly, some steps may be omitted, or some steps may be added.

The above-described method may be provided as a computer program stored in a computer-readable recording medium to be executed on a computer. The medium may continuously store computer-executable programs, or may temporarily store them for execution or downloading. Also, the medium may be various recording means or storage means in a form in which a single or several pieces of hardware are combined, and is not limited to a medium directly connected to a certain computer system but may also be distributed on a network. Examples of the media may include magnetic media such as hard disks, floppy disks, and magnetic tapes, optical recording media such as CD-ROMs and DVDs, magneto-optical media such as floptical disks, and those configured to store program instructions including ROM, RAM, flash memory, and the like. Also, as examples of other media, recording media or storage media managed by app stores that distribute applications or other sites and servers that supply or distribute various software may also be mentioned.

The methods, operations, or techniques of the present disclosure may also be implemented by various means. For example, these techniques may be implemented in hardware, firmware, software, or a combination thereof. Those skilled in the art will understand that various exemplary logical blocks, modules, circuits, and algorithm steps described in connection with the disclosure herein may be implemented as electronic hardware, computer software, or combinations of both. To clearly illustrate this interchangeability of hardware and software, various exemplary components, blocks, modules, circuits, and steps have been described above generally in terms of their functionality. Whether such functionality is implemented as hardware or software depends on the specific application and design requirements imposed on the overall system. Those skilled in the art may implement the described functionality in various ways for each specific application, but such implementations should not be interpreted as causing a departure from the scope of the present disclosure.

In a hardware implementation, processing units used to perform the techniques may be implemented within one or more ASICs, DSPs, digital signal processing devices (DSPDs), programmable logic devices (PLDs), field-programmable gate arrays (FPGAs), processors, controllers, microcontrollers, microprocessors, electronic devices, other electronic units designed to perform the functions described in the present disclosure, a computer, or a combination thereof.

Thus, the various exemplary logical blocks, modules, and circuits described in connection with the present disclosure may be implemented or performed with a general-purpose processor, a DSP, an ASIC, an FPGA or other programmable logic device, discrete gate or transistor logic, discrete hardware components, or any combination of those designed to perform the functions described herein. A general-purpose processor may be a microprocessor, but alternatively, the processor may be any conventional processor, controller, microcontroller, or state machine. The processor may also be implemented as a combination of computing devices, for example, a combination of a DSP and a microprocessor, a plurality of microprocessors, one or more microprocessors in conjunction with a DSP core, or any other configuration.

In firmware and/or software implementations, the techniques may be implemented with instructions stored on computer-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, and the like. The instructions may be executable by one or more processors and may cause the processor(s) to perform specific aspects of the functionality described in the present disclosure.

Although the various features described above have been described as utilizing aspects of the currently disclosed subject matter in one or more standalone computer systems, the present disclosure is not limited thereto and may be implemented in connection with any computing environment such as a network or distributed computing environment. Furthermore, aspects of the subject matter in the present disclosure may be implemented in a plurality of processing chips or devices, and storage may be similarly affected across a plurality of devices. These devices may include PCs, network servers, and portable devices.

Although the present disclosure has been described in connection with some embodiment(s) in the present specification, various modifications and changes can be made without departing from the scope of the present disclosure that can be understood by those skilled in the art to which the invention of the present disclosure pertains. Also, such modifications and changes should be considered to fall within the scope of the patent claims attached to this specification.

What is claimed is:

1. A method performed by at least one processor, the method comprising:
receiving, from a sender, encrypted data;
receiving, from the sender, an encrypted encryption key;
performing a cryptographic verification, using digital signature technology, on information generated with a receiver private key;
determining, based on the cryptographic verification, that a receiver possesses the receiver private key; and
transmitting, based on determining that the receiver possesses the receiver private key, the encrypted data and the encrypted encryption key to the receiver.

2. The method of claim 1, wherein the encrypted encryption key is encrypted based on a sender private key and a receiver public key, and wherein the encrypted encryption key is decrypted based on the receiver private key and a sender public key.

3. A method performed by at least one processor, the method comprising:
receiving, from a sender, encrypted data;
receiving, from the sender, first receiver identification information;
receiving, from a receiver, a receiver public key;
receiving, from the receiver, second receiver identification information;
determining, based on the first receiver identification information and the second receiver identification information, that the receiver possesses the first receiver identification information;
verifying information generated with a receiver private key;
determining, based on the verifying of the information, that the receiver possesses the receiver private key;
transmitting, based on determining that the receiver possesses the first receiver identification information and the receiver private key, the receiver public key to the sender;
receiving, from the sender, an encrypted encryption key generated based on the receiver public key; and
transmitting the encrypted data and the encrypted encryption key to the receiver.

4. The method of claim 3, wherein the determining that the receiver possesses the first receiver identification information comprises:
comparing the first receiver identification information with the second receiver identification information,
wherein the first receiver identification information and the second receiver identification information are one-way encrypted.

5. The method of claim 3, wherein the verifying of the information comprises performing a cryptographic verification, using digital signature technology, on the information.

6. The method of claim 5, further comprising:
verifying the second receiver identification information by:
receiving verification information from a database of a verification authority;
determining, using a verification authority public key, validity of a signature included in the verification information;
validating, based on determining the validity of the signature, the verification information; and
comparing the validated verification information with the second receiver identification information.

7. The method of claim 3, wherein the encrypted encryption key is encrypted based on a sender private key and the receiver public key, and wherein the encrypted encryption key is decrypted based on the receiver private key and a sender public key.

8. An apparatus comprising:
a communication interface;
at least one processor; and
a memory storing instructions configured to be executed by the at least one processor to cause the apparatus to:
receive, via the communication interface, encrypted data from a sender,
receive, via the communication interface, first receiver identification information from the sender,
receive, via the communication interface, a receiver public key from a receiver,
receive, via the communication interface, second receiver identification information from the receiver,
determine, based on the first receiver identification information and the second receiver identification information, that the receiver possesses the first receiver identification information,
verify information generated with a receiver private key,
determine, based on the verification of the information, that the receiver possesses the receiver private key,
transmit, via the communication interface, based on determining that the receiver possesses the first receiver identification information and the receiver private key, the receiver public key to the sender,
receive, via the communication interface, an encrypted encryption key generated based on the receiver public key from the sender, and
transmit, via the communication interface, the encrypted data and the encrypted encryption key to the receiver.

9. The apparatus of claim 8, wherein the instructions are configured to be executed by the at least one processor to cause the apparatus to:
determine that the receiver possesses the first receiver identification information by comparing the first receiver identification information with the second receiver identification information,
wherein the first receiver identification information and the second receiver identification information are one-way encrypted.

10. The apparatus of claim 8, wherein the instructions are configured to be executed by the at least one processor to cause the apparatus to:
verify the information by performing a cryptographic verification, using digital signature technology, on the information.

11. The apparatus of claim 10, wherein the instructions are configured to be executed by the at least one processor to cause the apparatus to verify the second receiver identification information by:
receiving, via the communication interface, verification information from a database of a verification authority;
determining, using a verification authority public key, validity of a signature included in the verification information;
validating, based on determining the validity of the signature, the verification information; and
comparing the validated verification information with the second receiver identification information.

12. The apparatus of claim 8, wherein the encrypted encryption key is encrypted based on a sender private key and the receiver public key, and wherein the encrypted encryption key is decrypted based on the receiver private key and a sender public key.

13. A computer-readable medium storing instructions that, when executed, cause performance of the method of claim 1.
